(19) United States
(12) Patent Application Publication
(10) Pub. No.: US 2014/0016191 A1
(43) Pub. Date: Jan. 16, 2014

(54) WINDOW SHUTTER APPARATUS AND ARCHITECTURAL OPTICAL ASSEMBLIES THEREOF

(71) Applicant: CHI LIN TECHNOLOGY CO., LTD., Tainan City (TW)

(72) Inventors: CHIA CHANG YEH, TAINAN CITY (TW); HSIN-YUNG LIN, TAINAN CITY (TW); CHI-WEN LIN, TAINAN CITY (TW); YING-CHANG SU, TAINAN CITY (TW)

(21) Appl. No.: 13/935,237

(22) Filed: Jul. 3, 2013

(30) Foreign Application Priority Data
Jul. 10, 2012 (TW) 101124832

(51) Int. Cl. G02B 5/20

(52) U.S. Cl. CPC G02B 5/208
USPC 359/361

(57) ABSTRACT

The present invention relates to a window shutter apparatus and architectural optical assemblies thereof. The architectural optical assembly includes a discolorable element and a light-shielding element. The discolorable element is used for receiving the light beam to exhibit discoloration effect. The light-shielding element is disposed adjacent to the discolorable element and used for shielding a part of the light beam having a wavelength within a predetermined range. Thereby, the architectural optical assembly has both light-shielding effect and light-transmitting effect. Furthermore, the architectural optical assembly can be applied to a window shutter apparatus. Whereby, the window shutter apparatus has both light-shielding effect and light-transmitting effect.

### BACKGROUND OF THE INVENTION

1. Field of the Invention

The present invention relates to a window shutter apparatus and architectural optical assemblies thereof, and more particularly to a window shutter apparatus and architectural optical assemblies thereof that can change the incident light beam.

2. Description of the Related Art

The conventional light-guiding apparatus is of various types, one of which is a film having microstructures. The film is disposed on or near a window of a room and used for guiding the sunlight beams outside the room into the room. The sunlight beams are directed to illuminate a reflector on the ceiling in the room. Then, the sunlight beams are reflected by the reflector, and used for indoor lighting or auxiliary illumination.

However, the light-guiding apparatus of the film having microstructures only has a single light-guiding function. If the light-guiding function is not necessary, the usage of such light-guiding apparatus is limited.

Therefore, it is necessary to provide a window shutter apparatus and architectural optical assemblies thereof to solve the above problem.

### SUMMARY OF THE INVENTION

The present invention is directed to an architectural optical assembly used for receiving light beam. The architectural optical assembly comprises a discolorable element and a light-shielding element. The discolorable element is used for receiving the light beam to exhibit discoloration effect. The light-shielding element is disposed adjacent to the discolorable element and used for shielding a part of the light beam having a wavelength within a predetermined range. Thereby, the architectural optical assembly has both light-shielding effect and light-transmitting effect.

The present invention is further directed to a window shutter apparatus for receiving light beam. The window shutter apparatus comprises a plurality of seats, a plurality of architectural optical assemblies and a controlling apparatus. Each of the architectural optical assemblies is disposed on each of the seats, and comprises a discolorable element and a light-shielding element. The discolorable element is used for receiving the light beam to exhibit discoloration effect. The light-shielding element is disposed adjacent to the discolorable element and used for shielding a part of the light beam having a wavelength within a predetermined range. The controlling apparatus is used for controlling the rotation of the seats. Thereby, the window shutter apparatus has both light-shielding effect and light-transmitting effect.

### BRIEF DESCRIPTION OF THE DRAWINGS

FIG. 1 is a cross-sectional view of an architectural optical assembly according to an embodiment of the present invention.

FIG. 2 is a cross-sectional view of an architectural optical assembly according to another embodiment of the present invention.

FIG. 3 is a cross-sectional view of an architectural optical assembly according to another embodiment of the present invention.

FIG. 4 is a perspective view of a light-guiding film according to an embodiment of the present invention.

FIG. 5 is a side view of the light-guiding film of FIG. 5.

FIG. 6 is a partially enlarged view of FIG. 5.

FIG. 7 is a cross-sectional view of an architectural optical assembly according to another embodiment of the present invention.

FIG. 8 is a cross-sectional view of an architectural optical assembly according to another embodiment of the present invention.

FIG. 9 is a perspective view of a window shutter apparatus according to an embodiment of the present invention.

FIG. 10 is a perspective exploded view of a first plate of a window shutter apparatus according to an embodiment of the present invention.

FIG. 11 is a perspective assembly view of a first plate of a window shutter apparatus according to an embodiment of the present invention.

FIG. 12 is a first operation of the window shutter apparatus of FIG. 9.

FIG. 13 is a second operation of the window shutter apparatus of FIG. 9.

FIG. 14 is a perspective view of a window shutter apparatus according to another embodiment of the present invention.

FIG. 15 is a perspective exploded view a first plate of a window shutter apparatus according to another embodiment of the present invention.

### DETAILED DESCRIPTION OF THE INVENTION

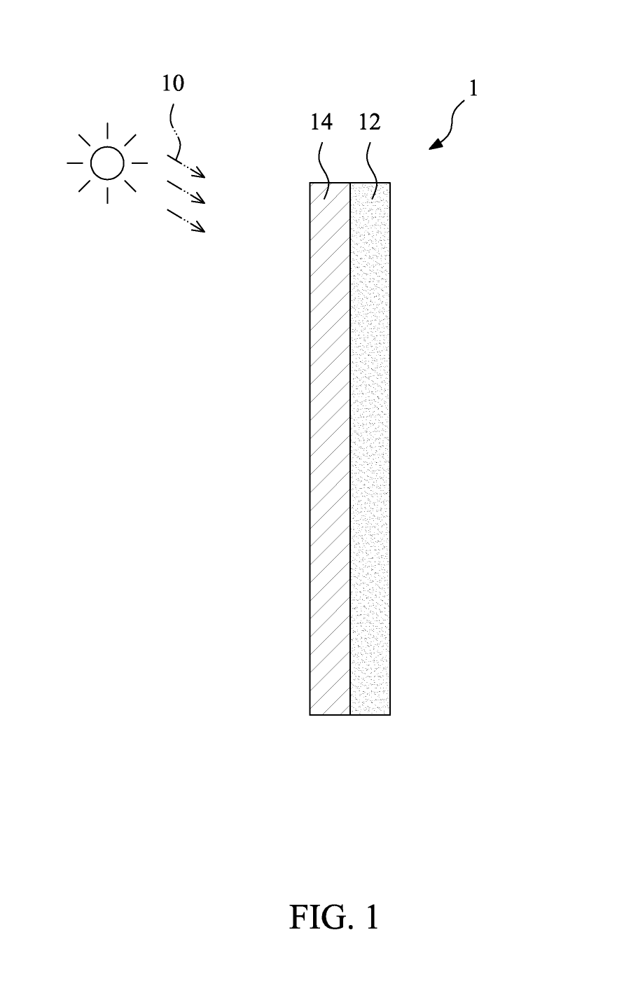

FIG. 1 shows a cross-sectional view of an architectural optical assembly according to an embodiment of the present invention. The architectural optical assembly 1 is used for receiving light beam 10 and comprises a discolorable element 12 and a light-shielding element 14. The discolorable element 12 is used for receiving the light beam 10 to exhibit discoloration effect. The light-shielding element 14 is disposed adjacent to the discolorable element 12 and used for shielding a part of the light beam 10 having a wavelength within a predetermined range.

In this embodiment, the light beam 10 is the sunlight beam, and at least has visible light and ultraviolet (UV) light. The discolorable element 12 is a UV-photochromic film or a thermochromic film, which includes a film base and an additive agent. The material of the film base is, e.g., polymethyl methacrylate (PMMA), arcylic-based polymer, polycarbonate (PC), polyethylene terephthalate (PET), polystyrene (PS), or a copolymer thereof. The additive agent is dispersed in the filem base, and the material thereof is, e.g., UV-activated photochromic dye, UV-activated photochromic powder, UV-activated photochromic ink, thermochromic dye, thermochromic powder or thermochromic ink. In this embodiment, the discolorable element 12 is a UV-photochromic film. That is, when the discolorable element 12 is not illuminated by any ultraviolet (UV) light, it is transparent, whereas when the discolorable element 12 is illuminated by ultraviolet (UV) light, it will absorb the ultraviolet (UV) light to exhibit discoloration effect (becomes dark), so as to block or shield light transmission, and has the light-shielding effect.

In this embodiment, the light-shielding element 14 is an anti-ultraviolet (UV) light film. The light beam having a wavelength within a predetermined range is ultraviolet (UV) light. Preferably, the light-shielding element 14 can shield more than 60% of ultraviolet (UV) light, and let other light pass through it. In this embodiment, the discolorable element 12 and the light-shielding element 14 are the films formed individually, and then combined together to form the architectural optical assembly 1. However, in other embodiment, the light-shielding element 14 is attached to the discolorable element 12 by, e.g., coating or bonding, to form a single film. Alternatively, the discolorable element 12 may be attached to the light-shielding element 14 by, e.g., coating or bonding, to form a single film.

As shown in FIG. 1, the light-shielding element 14 faces the light beam 10. Meanwhile, the light-shielding element 14 shields the ultraviolet (UV) light of the light beam 10, and let other light (e.g., visible light) pass through. At the same time, since the discolorable element 12 is not illuminated by ultraviolet (UV) light, it is transparent. Therefore, the architectural optical assembly 1 is light-transmissive. That is, the visible light of the light beam 10 can pass through the light-shielding element 14 and the discolorable element 12 and then reaches the right side of the figure, and the ultraviolet (UV) light will not reach the right side of the figure (or only less ultraviolet (UV) light reaches the right side of the figure).

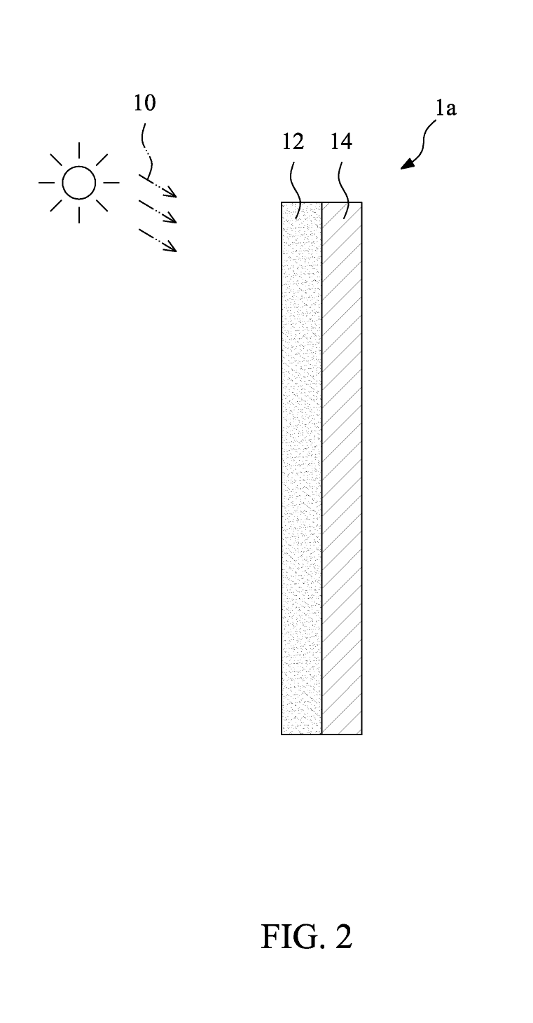

FIG. 2 shows a cross-sectional view of an architectural optical assembly according to another embodiment of the present invention. The architectural optical assembly 1a of this embodiment is similar to the architectural optical assembly 1 of FIG. 1, wherein the same elements are designated with the same reference numerals, and the difference is described as follows. In this embodiment, the discolorable element 12 of the architectural optical assembly 1a faces the light beam 10. Meanwhile, the discolorable element 12 is illuminated by the ultraviolet (UV) light of the light beam 10, it absorbs the ultraviolet (UV) light to exhibit discoloration effect (becomes dark), so as to block or shield the transmission of other light (e.g., visible light), or block or shield a part of the visible light. Therefore, the architectural optical assembly 1a is opaque. That is, the light beam 10 can not pass through the discolorable element 12 and the light-shielding element 14 to reach the right side of the figure (or only less light beam 10 reaches the right side of the figure). Meanwhile, the architectural optical assembly 1a has light-shielding effect. The difference between the architectural optical assembly 1a and the architectural optical assembly 1 of FIG. 1 is only the 180-degree turnover. Therefore, the architectural optical assemblies 1, 1a have both light-shielding effect and light-transmitting effect.

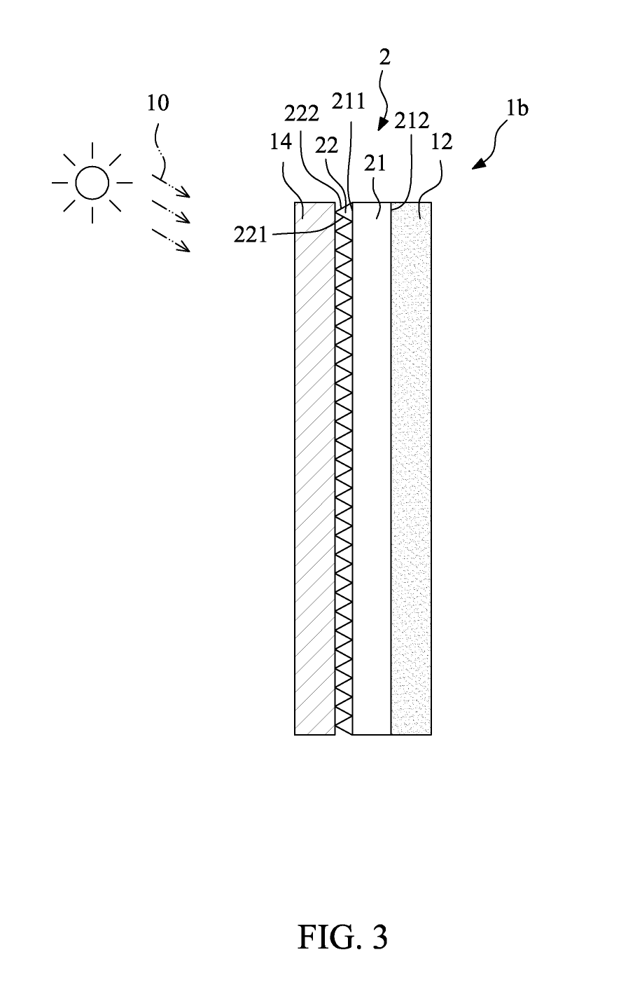

FIG. 3 shows a cross-sectional view of an architectural optical assembly according to another embodiment of the present invention. The architectural optical assembly 1b of this embodiment is similar to the architectural optical assembly 1 of FIG. 1, wherein the same elements are designated with the same reference numerals, and the difference is described as follows. In this embodiment, the architectural optical assembly 1b further comprises a light-guiding film 2 disposed between the discolorable element 12 and the light-shielding element 14.

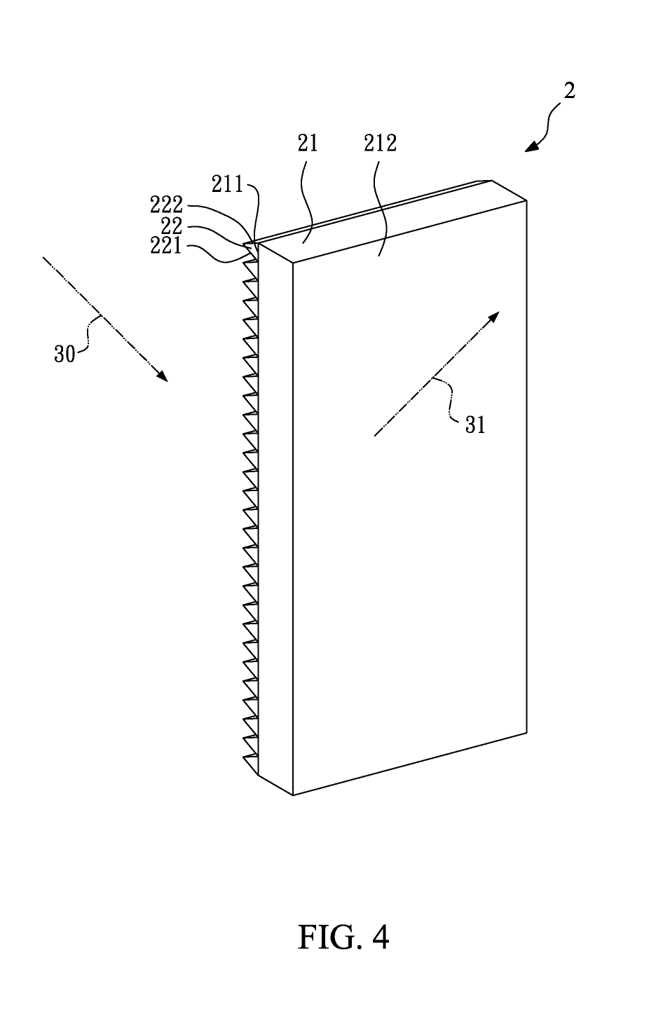

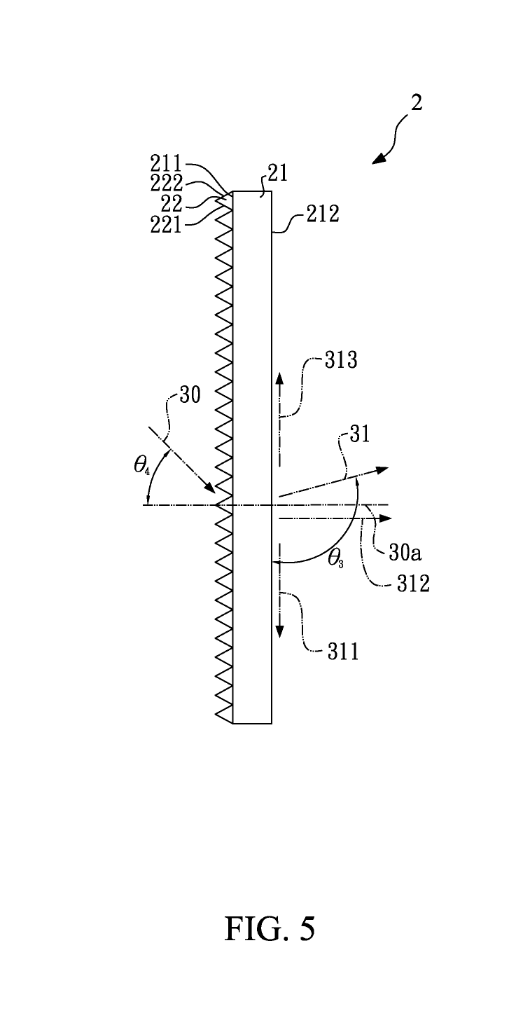

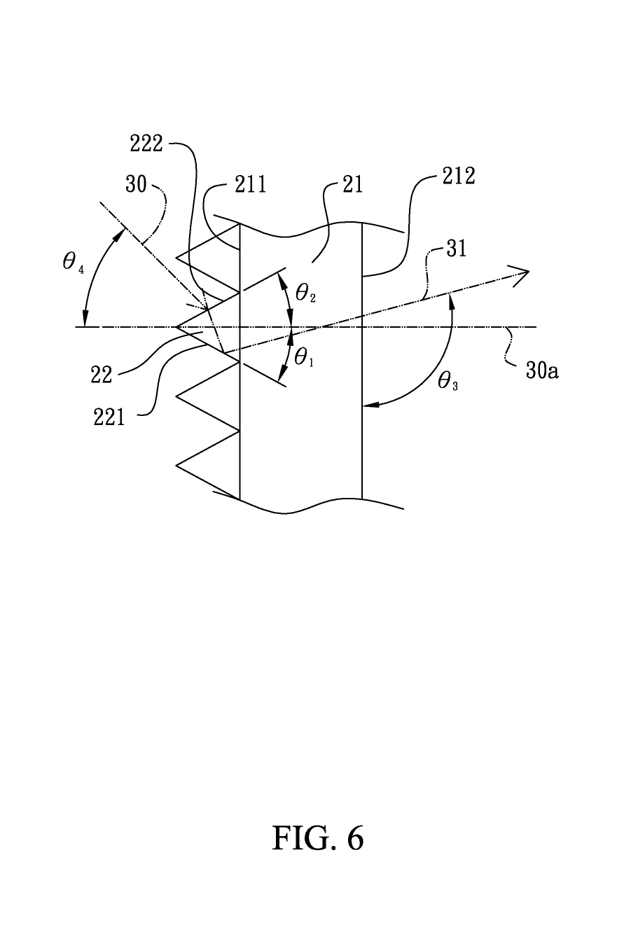

FIG. 4 shows a perspective view of a light-guiding film according to an embodiment of the present invention. FIG. 5 shows a side view of the light-guiding film of FIG. 5. FIG. 6 shows a partially enlarged view of FIG. 5. The light-guiding film 2 comprises a film base 21 and at least one microstructure 22. In this embodiment, the light-guiding film 2 comprises a plurality of microstructures 22. The film base 21 has a first side 211 and a second side 212, and the second side 212 is opposite the first side 211.

The microstructure 22 is disposed on the first side 211 or the second side 212 of the film base 21, and has a first surface 221 and a second surface 222. The second surface 222 is above the first surface 221. In this embodiment, the cross section of the microstructure 22 is substantially triangle, and the first surface 221 intersects the second surface 222.

A reference plane 30a is defined as a phantom plane that is perpendicular to the first side 211 or the second side 212 of the film base 21. That is, when the light-guiding film 2 stands upright, the reference plane 30a is a phantom horizontal plane. A first inclination angle θ₁ (FIG. 6) is between the first surface 221 and the reference plane 30a. A second inclination angle θ₂ (FIG. 6) is between the second surface 222 and the reference plane 30a, wherein the first inclination angle θ₁ is less than or equal to the second inclination angle θ₂.

As shown in FIG. 6, in this embodiment, the value of the first inclination angle θ₁ is between 11 to 19 degrees, the value of the second inclination angle θ₂ is between 52 to 68 degrees, and the sum of the first inclination angle θ₁ and the second inclination angle θ₂ is between 63 to 87 degrees. Preferably, the value of the first inclination angle θ₁ is 15 degrees, and the value of the second inclination angle θ₂ is 60 degrees.

The material of the film base 21 may be different from that of the microstructure 22. The film base 21 is made of light transmissive material, such as polymethyl methacrylate (PMMA), arcylic-based polymer, polycarbonate (PC), polyethylene terephthalate (PET), polystyrene (PS), or a copolymer thereof, with a refraction index of 1.35 to 1.65.

The microstructure 22 is made of metal oxide, such as TiO₂ or Ta₂O₅, with a refraction index of 1.9 to 2.6. In one embodiment, a layer of the metal oxide is formed on the film base 21, then, the microstructure 22 is formed by etching. It is understood that the material of the film base 21 may be same as that of the microstructure 22.

In this embodiment, a plurality of incident light beams 30 becomes a plurality of output light beams 31 after passing through the light-guiding film 2. As shown in FIG. 5, an output angle θ₃ is defined as the angle between the output light beam 31 and the light-guiding film 2. The output angle θ₃ is defined as 0 degree when the output light beam (i.e., the output light beam 311) is downward and parallel with the light-guiding film 2. The output angle θ₃ is defined as 90 degrees when the output light beam (i.e., the output light beam 312) is horizontal and parallel with the reference plane 30a. The output angle θ₃ is defined as 180 degrees when the output light beam (i.e., the output light beam 313) is upward and parallel with the light-guiding film 2.

An incident angle θ₄ is defined as the angle between the incident light beam 30 and the reference plane 30a. The incident angle θ₄ is defined as positive value when the incident light beam 30 is downward. The incident angle θ₄ is defined as 0 degree when the incident light beam (not shown) is horizontal and parallel with the reference plane 30a, and the incident angle θ₄ is defined as negative value when the incident light beam (not shown) is upward.

As shown in FIG. 6, the incident light beams 30 enter the microstructure 22 through the second surface 222 of the microstructure 22 by refraction, and are reflected by the first surface 221 of the microstructure 22. Then, the reflected incident light beams 30 pass through the film base 21 to become the output light beams 31. It is to be noted that the incident light beams 30 are reflected by the first surface 221 due to the specific design of the first inclination angle θ₁ and the second inclination angle θ₂. Therefore, when the incident angles θ₄ of the incident light beams 30 are in the range of 30 to 60 degrees downward, more than 50% of the output light beams 31 are upward. Further, the output light beams 31 will concentrate in a specific range of the output angle θ₃, that is, the total luminous flux of the output light beams 31 with the specific range of the output angle is a peak when it is compared with other output light beams 31 with other range of the output angle.

In one embodiment, the incident angles θ₄ of the incident light beams 30 are from 30 to 60 degrees, and the total luminous flux of the output light beams 31 with the output angles from 85 to 120 degrees is more than 40% of the total luminous flux of the output light beams 31 with the output angles from 0 to 180 degrees.

Referring to FIG. 3 again, the light-shielding element 14 faces the light beam 10. Meanwhile, the light-shielding element 14 shields the ultraviolet (UV) light of the light beam 10, and let other light (e.g., visible light) pass through. Then, a part of said other light (e.g., visible light) is guided upward by the light-guiding film 2 to pass through the discolorable element 12. Since the discolorable element 12 is not illuminated by ultraviolet (UV) light, it is transparent. Therefore, the architectural optical assembly 1b is light-transmissive and has the light-guiding effect. That is, the visible light of the light beam 10 can pass through the light-shielding element 14, the light-guiding film 2 and the discolorable element 12, and reach the right side of the figure. A part of the visible light can reach the upper right side of the figure. In addition, the ultraviolet (UV) light will not reach the right side of the figure (or only less ultraviolet (UV) light reaches the right side of the figure).

In this embodiment, the discolorable element 12, the light-guiding film 2 and the light-shielding element 14 are the films formed individually, and then combined together to form the architectural optical assembly 1b. However, in other embodiment, the light-shielding element 14 is attached to the light-guiding film 2 by, e.g., coating or bonding, to form a single film. Alternatively, the discolorable element 12 may be attached to the light-guiding film 2 by, e.g., coating or bonding, to form a single film.

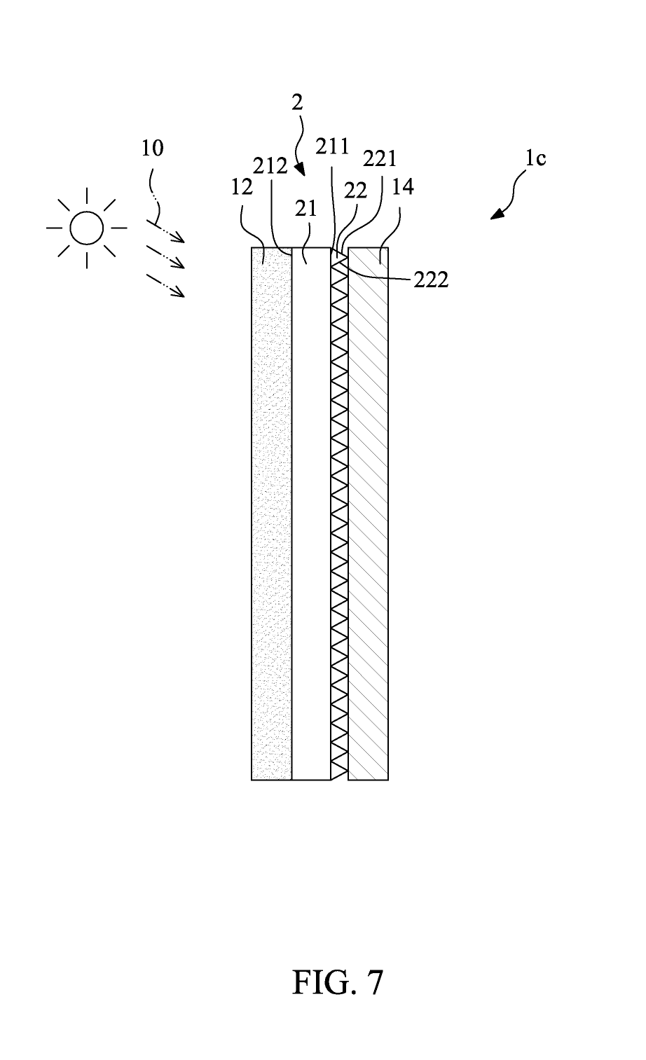

FIG. 7 shows a cross-sectional view of an architectural optical assembly according to another embodiment of the present invention. The architectural optical assembly 1c of this embodiment is similar to the architectural optical assembly 1a of FIG. 2, wherein the same elements are designated with the same reference numerals, and the difference is described as follows. In this embodiment, the architectural optical assembly 1c further comprises the light-guiding film 2 disposed between the discolorable element 12 and the light-shielding element 14.

In this embodiment, the discolorable element 12 of the architectural optical assembly 1c faces the light beam 10. Meanwhile, the discolorable element 12 is illuminated by the ultraviolet (UV) light of the light beam 10, it absorbs the ultraviolet (UV) light to exhibit discoloration effect (becomes dark), so as to block or shield the transmission of other light (e.g., visible light), or block or shield a part of the visible light. Therefore, the architectural optical assembly 1c is opaque. That is, the light beam 10 can not pass through the discolorable element 12, the light-guiding film 2 and the light-shielding element 14 to reach the right side of the figure (or only less light beam 10 reaches the right side of the figure). Meanwhile, the architectural optical assembly 1c has light-shielding effect.

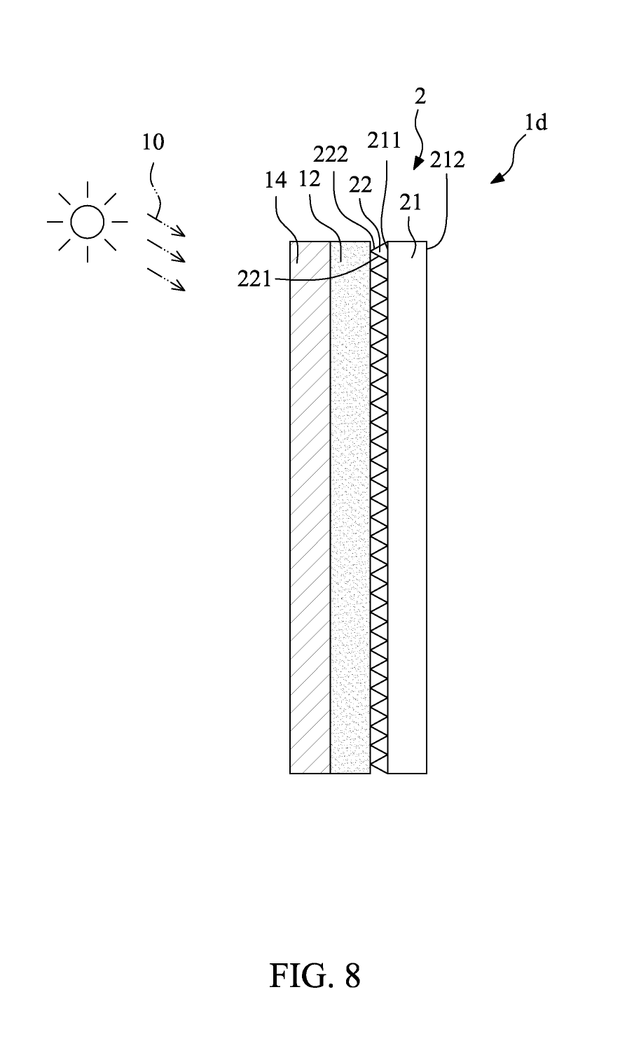

FIG. 8 shows a cross-sectional view of an architectural optical assembly according to another embodiment of the present invention. The architectural optical assembly 1d of this embodiment is similar to the architectural optical assembly 1b of FIG. 3, wherein the same elements are designated with the same reference numerals, and the difference is described as follows. In this embodiment, the discolorable element 12 of the architectural optical assembly 1d is disposed between the light-guiding film 2 and the light-shielding element 14. Therefore, the optical effect of the architectural optical assembly 1d is substantially the same as that of the architectural optical assembly 1b of FIG. 3.

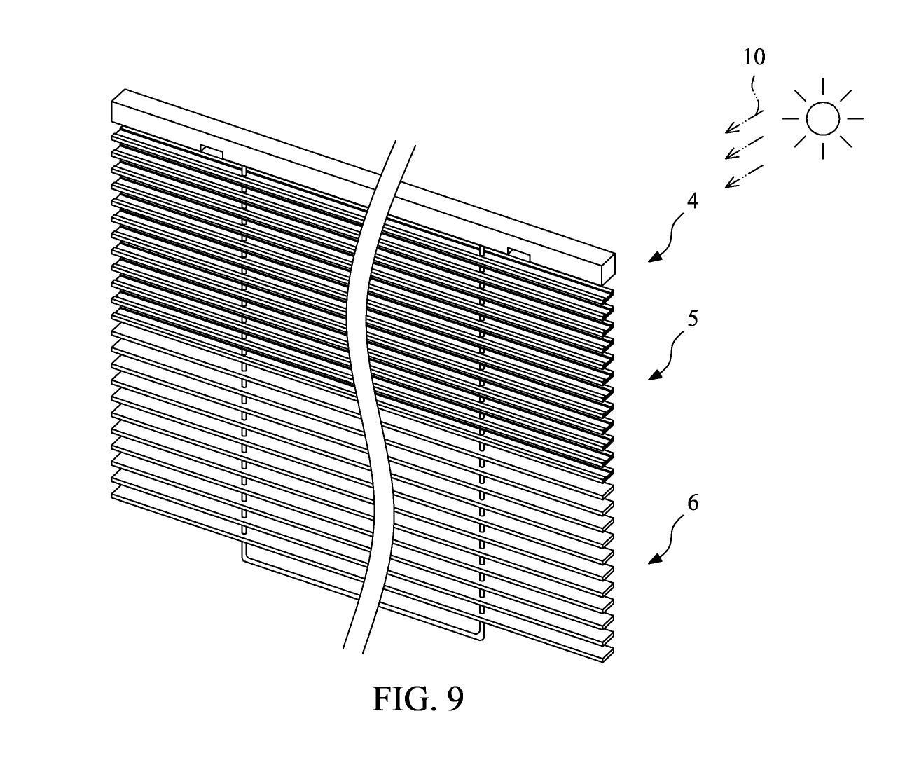

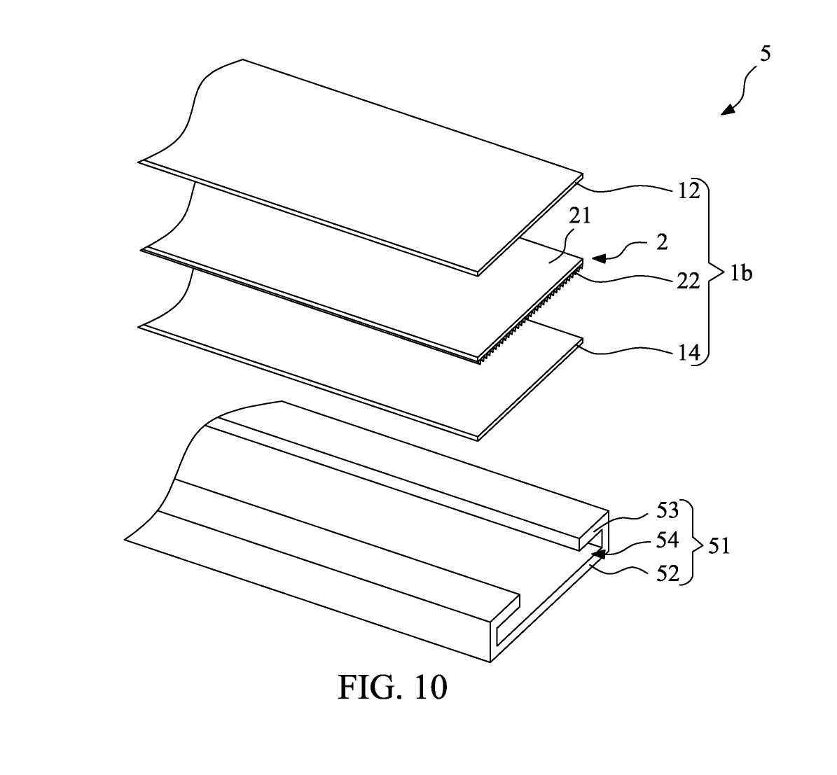

FIG. 9 shows a perspective view of a window shutter apparatus according to an embodiment of the present invention. The window shutter apparatus 4 is used for receiving the light beam 10. The window shutter apparatus 4 comprises a plurality of first plates 5, a plurality of second plates 6 and a controlling apparatus (not shown). In this embodiment, the first plates 5 are different from the second plates 6, and the first plates 5 are disposed above the second plates 6. Each of the first plates 5 comprises a seat 51 and an architectural optical assembly 1b (FIG. 10). The first plates 5 are substantially parallel to each other (that is, the seats 51 are substantially parallel to each other), and are light-transmissive. The second plates 6 are opaque plates (e.g., metal, wood, opaque plastic, etc.) and are parallel to the seats 51. The controlling apparatus is used for controlling the rotation of the seats 51 of the first plates 5 and the second plates 6.

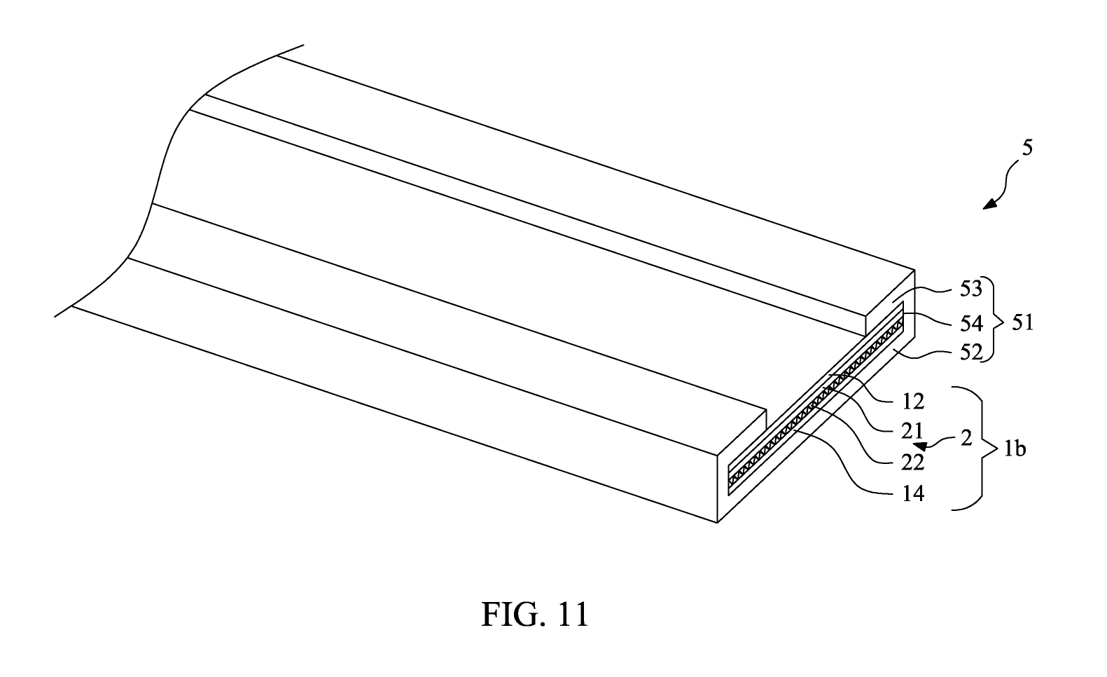

FIGS. 10 and 11 respectively show a perspective exploded view and a perspective assembly view of a first plate of a window shutter apparatus according to an embodiment of the present invention. Each of the first plates 5 comprises a seat 51 and an architectural optical assembly 1b (FIG. 10). The seat 51 is used for receiving the architectural optical assembly 1b, and includes a base 52 and two clip plates 53. The clip plates 53 are disposed above two opposite sides of the base 52, and the clip plates 53 and the base 52 define an accommodating space 54. Preferably, the seat 51 is made of transparent plastic, and the clip plates 53 and the base 52 are made integrally.

The architectural optical assembly 1b is disposed on the seat 51. In this embodiment, the architectural optical assembly 1b is inserted in the accommodating space 54 between the clip plates 53 and the base 52, so that the light-shielding element 14 contacts the base 52, and the discolorable element 12 contacts the clip plates 53. In this embodiment, the architectural optical assembly 1b is the architectural optical assembly 1b of FIG. 3. It is understood that the architectural optical assembly 1b may be replaced with the architectural optical assembly 1 of FIG. 1, the architectural optical assembly 1a of FIG. 2, the architectural optical assembly 1c of FIG. 7, or the architectural optical assembly 1d of FIG. 8.

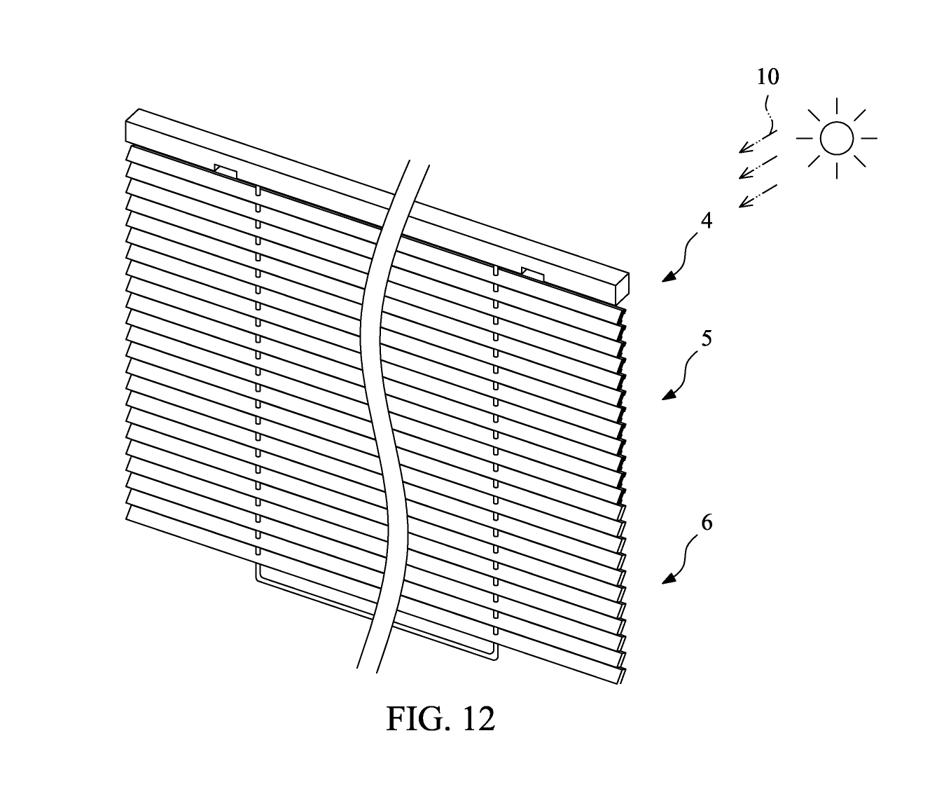

FIG. 12 shows a first operation of the window shutter apparatus of FIG. 9. The figure shows the situation of actual usage of the window shutter apparatus 4, wherein the right side of the figure represents outdoor location, the light beam 10 is the sunlight beam, and the left side of the figure represents indoor location. During operation, the user actuates or starts the controlling apparatus to drive the first plates 5 and the second plates 6 to rotate. As shown in FIG. 12, the first plates 5 and the second plates 6 are driven to rotate to a position perpendicular to the ground, so that the light-shielding elements 14 of the first plates 5 face the light beam 10 (that is, the light-shielding elements 14 face toward the outdoor side), and such situation is similar to FIG. 3. Meanwhile, the light-shielding elements 14 shield the ultraviolet (UV) light of the light beam 10, and let other light (e.g., visible light) pass through. Then, a part of said other light (e.g., visible light) is guided upward by the light-guiding film 2 to pass through the discolorable elements 12. Since the discolorable elements 12 are not illuminated by ultraviolet (UV) light, they are transparent. Therefore, the first plates 5 are light-transmissive and have the light-guiding effect. That is, the visible light of the light beam 10 can pass through the first plates 5, and reach the left side of the figure. A part of the visible light can reach the upper left side of the figure. Further, the ultraviolet (UV) light will not reach the left side of the figure (or only less ultraviolet (UV) light reaches the left side of the figure). In addition, the second plates 6 shield or block the light beam 10 completely. Therefore, in this first operation, the window shutter apparatus 4 exhibits the effect of guiding a part of the light beam 10 to the upper left side of the figure.

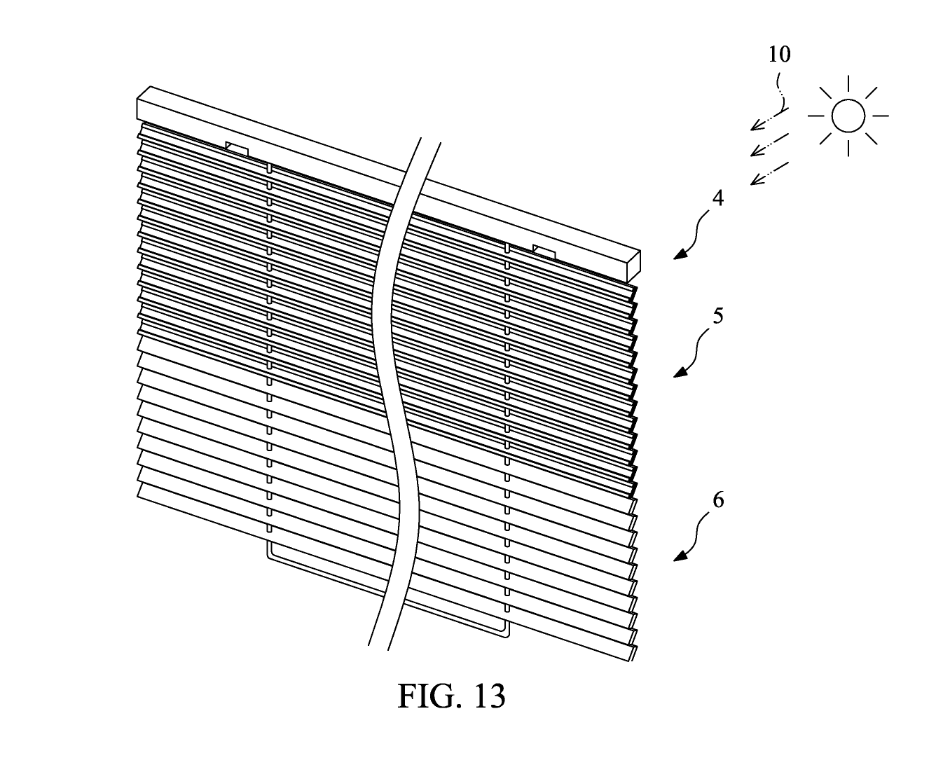

FIG. 13 shows a second operation of the window shutter apparatus of FIG. 9. The user actuates or starts the controlling apparatus to drive the first plates 5 and the second plates 6 to rotate. As shown in FIG. 13, the first plates 5 and the second plates 6 are driven to rotate to a position perpendicular to the ground, so that the discolorable elements 12 of the first plates 5 face the light beam 10 (that is, the discolorable elements 12 face toward the outdoor side), and such situation is similar to FIG. 7. Meanwhile, the discolorable elements 12 are illuminated by the ultraviolet (UV) light of the light beam 10, they absorb the ultraviolet (UV) light to exhibit discoloration effect (become dark), so as to block or shield the transmission of other light (e.g., visible light), or block or shield a part of the visible light. Therefore, the first plates 5 are opaque. That is, the light beam 10 can not pass through the first plates 5 to reach the left side of the figure (or only less light beam 10 reaches the left side of the figure). In addition, the second plates 6 still shield or block the light beam 10 completely. Therefore, in this second operation, the window shutter apparatus 4 exhibits the effect of almost shielding or blocking the whole light beam 10. That is, the window shutter apparatus 4 has the light-shielding effect. Therefore, by changing the angle of the plates (the first plates 5 and the second plates 6), the window shutter apparatus 4 have both light-shielding effect and light-transmitting effect, and can prevent the ultraviolet (UV) light from entering the room.

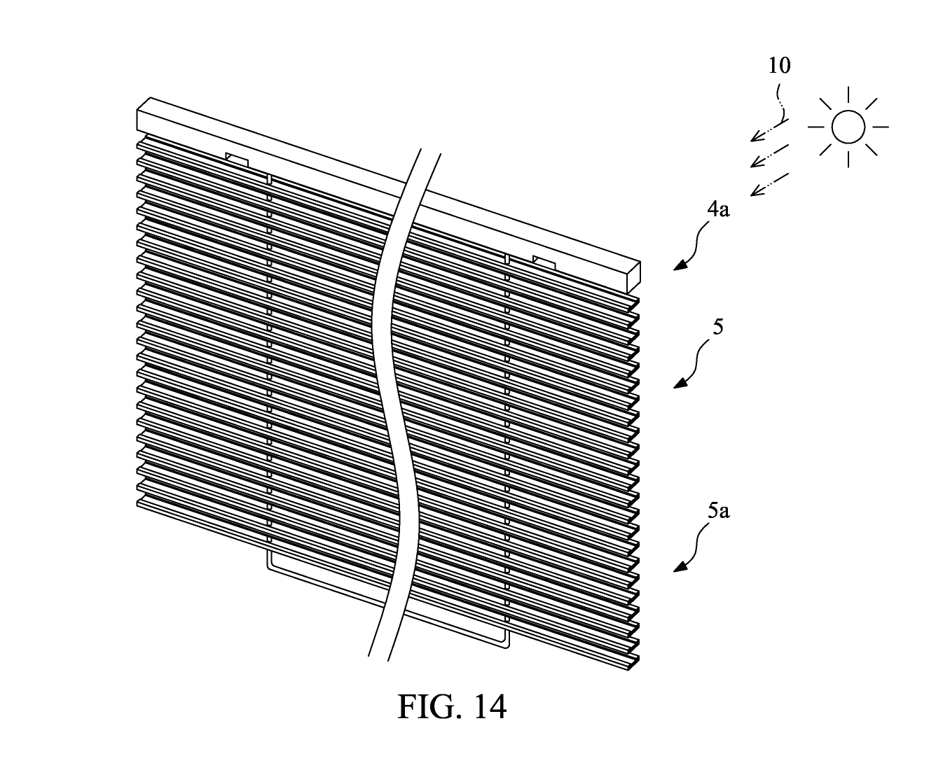

FIG. 14 shows a perspective view of a window shutter apparatus according to another embodiment of the present invention. The window shutter apparatus 4a of this embodiment is similar to the window shutter apparatus 4 of FIG. 9, wherein the same elements are designated with the same reference numerals, and the difference is described as follows. In this embodiment, the window shutter apparatus 4a comprises a plurality of first plates 5, a plurality of second plates 5a and a controlling apparatus (not shown). The first plates 5 of the window shutter apparatus 4a are the same as the first plates 5 of the window shutter apparatus 4 of FIG. 9. Each of the second plates 5a is similar to each of the first plates 5, and has a seat 51 (FIG. 10). However, the architectural optical assembly inserted in each of the second plates 5a may be the same as or different from the architectural optical assembly inserted in each of the first plates 5, and it depends on the actual requirement.

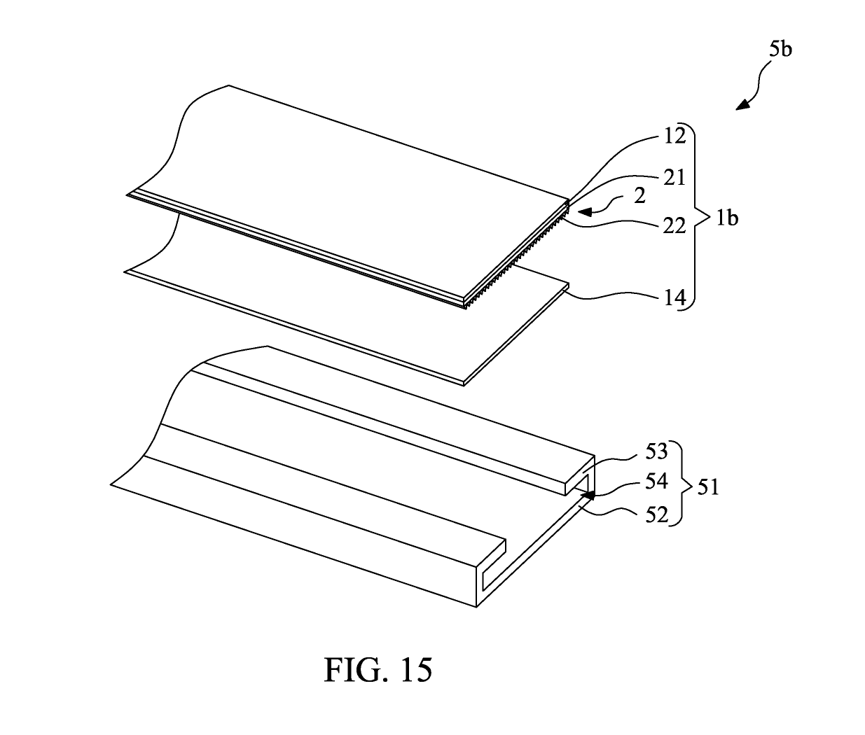

FIG. 15 shows a perspective exploded view a first plate of a window shutter apparatus according to another embodiment of the present invention. The first plate 5b of this embodiment is similar to the first plate 5 of FIG. 10, wherein the same elements are designated with the same reference numerals, and the difference is described as follows. In the first plate 5 of FIG. 10, the discolorable element 12, the light-guiding film 2 and the light-shielding element 14 are the films formed individually, and then inserted into the accommodating space 54. However, in the first plate 5b of this embodiment, the discolorable element 12 is attached to the light-guiding film 2 by, e.g., coating or bonding, to form a single film, and then said single film accompanying with the light-shielding element 14 are inserted into the accommodating space 54.

While several embodiments of the present invention have been illustrated and described, various modifications and improvements can be made by those skilled in the art. The embodiments of the present invention are therefore described in an illustrative but not restrictive sense. It is intended that the present invention should not be limited to the particular forms as illustrated, and that all modifications which maintain the spirit and scope of the present invention are within the scope defined in the appended claims.

What is claimed is:

1. An architectural optical assembly used for receiving light beam, and comprising:
a discolorable element, used for receiving the light beam to exhibit discoloration effect; and
a light-shielding element, disposed adjacent to the discolorable element and used for shielding a part of the light beam having a wavelength within a predetermined range.

2. The architectural optical assembly as claimed in claim 1, wherein the light beam is the sunlight beam.

3. The architectural optical assembly as claimed in claim 1, wherein the discolorable element is a UV-photochromic film or a thermochromic film.

4. The architectural optical assembly as claimed in claim 1, wherein the light beam further has visible light, and the discolorable element is used for shielding a part of the visible light.

5. The architectural optical assembly as claimed in claim 1, wherein the light beam having a wavelength within a predetermined range is ultraviolet (UV) light.

6. The architectural optical assembly as claimed in claim 1, wherein the light-shielding element shields more than 60% of ultraviolet (UV) light.

7. The architectural optical assembly as claimed in claim 1, further comprising a light-guiding film, wherein the light-guiding film comprises:
a film base, having a first side and a second side opposite the first side; and
at least one microstructure, disposed on the first side or the second side of the film base, and having a first surface and a second surface above the first surface, wherein a first inclination angle is between the first surface and a reference plane, the reference plane is perpendicular to the film base, a second inclination angle is between the second surface and the reference plane;
whereby a plurality of incident light beams becomes a plurality of output light beams after passing through the light-guiding film, an output angle is defined as the angle between the output light beam and the light-guiding film, the output angle is defined as 0 degree when the output light beam is downward and parallel with the light-guiding film, the output angle is defined as 180 degrees when the output light beam is upward and parallel with the light-guiding film, the total luminous flux of the output light beams with the output angles from 85 to 120 degrees is more than 40% of the total luminous flux of the output light beams with the output angles from 0 to 180 degrees.

8. A window shutter apparatus for receiving light beam, and comprising:
a plurality of seats;
a plurality of architectural optical assemblies, each of the architectural optical assemblies being disposed on each of the seats, and comprising:
a discolorable element, used for receiving the light beam to exhibit discoloration effect; and
a light-shielding element, disposed adjacent to the discolorable element and used for shielding a part of the light beam having a wavelength within a predetermined range; and
a controlling apparatus, used for controlling the rotation of the seats.

9. The window shutter apparatus as claimed in claim 8, wherein each of the seats includes a base and two clip plates, and each of the architectural optical assemblies is inserted between the base and the clip plates.

10. The window shutter apparatus as claimed in claim 8, wherein the seats are substantially parallel to each other.

11. The window shutter apparatus as claimed in claim 8, wherein each of the architectural optical assemblies further comprises a light-guiding film, the light-guiding film comprises:
a film base, having a first side and a second side opposite the first side; and
at least one microstructure, disposed on the first side or the second side of the film base, and having a first surface and a second surface above the first surface, wherein a first inclination angle is between the first surface and a reference plane, the reference plane is perpendicular to the film base, a second inclination angle is between the second surface and the reference plane;
whereby a plurality of incident light beams becomes a plurality of output light beams after passing through the light-guiding film, an output angle is defined as the angle between the output light beam and the light-guiding film, the output angle is defined as 0 degree when the output light beam is downward and parallel with the light-guiding film, the output angle is defined as 180 degrees when the output light beam is upward and parallel with the light-guiding film, the total luminous flux of the output light beams with the output angles from 85 to 120 degrees is more than 40% of the total luminous flux of the output light beams with the output angles from 0 to 180 degrees.

12. The window shutter apparatus as claimed in claim 8, further comprising a plurality of opaque plates parallel to the seats.

13. The window shutter apparatus as claimed in claim 8, wherein the seats are light-transmissive.
